(19) United States
(12) Patent Application Publication
(10) Pub. No.: US 2026/0163593 A1
(43) Pub. Date: Jun. 11, 2026

(54) Home network system and high-speed home network transmission device and high-speed home network receiving device thereof

(71) Applicant: REALTEK SEMICONDUCTOR CORPORATION, HSINCHU (TW)

(72) Inventors: ZHI-ZHEN CHIANG, Milpitas, CA (US); MENG-CHIEH TSAO, San Jose, CA (US)

(21) Appl. No.: 18/971,704

(22) Filed: Dec. 6, 2024

(51) Int. Cl. H04B 1/00; H04L 27/26; H04L 47/125; H04W 28/10; H04W 72/0453

(52) U.S. Cl. CPC H04B 1/0096; H04L 27/2666; H04L 47/125; H04W 28/10; H04W 72/0453

(57) ABSTRACT

The present disclosure discloses a home network system. A first network node includes a high-speed home network transmitting device to split, process and perform frequency up-shifting on a data signal to generate up-shifted data signals corresponding to radio frequency bands different and independent from each other so as to be combined to generate a transmitting data signal to be transmitted through a wired transmission media. A second network node includes a high-speed home network receiving device to separate, perform frequency down-shifting on and process the transmitting data signal to generate processed data signals to be reconstructed to generate the data signal.

### BACKGROUND OF THE INVENTION

### 1. Field of the Invention

The present disclosure relates to a home network system and a high-speed home network transmission device and a high-speed home network receiving device thereof.

### 2. Description of Related Art

As the demand for faster internet grows, a home network system is required to deliver stable and high-speed connections. However, the current home network setups are limited by the speed and reliability of the wireless devices in system.

### SUMMARY OF THE INVENTION

In consideration of the problem of the prior art, an object of the present disclosure is to provide a home network system and a high-speed home network transmission device and a high-speed home network receiving device thereof.

The present invention discloses a high-speed home network transmission device serving as a transmitter of a network node in a home network system that includes a traffic splitting circuit, a plurality of transmitting circuits, a plurality of mixer circuits and a combiner circuit. The traffic splitting circuit is configured to split a data signal of a data stream into a plurality of split data signals. The plurality of transmitting circuits are configured to correspondingly process the plurality of split data signals to generate a plurality of processed data signals. The plurality of mixer circuits are configured to correspondingly perform frequency up-shifting on the plurality of processed data signals to generate a plurality of up-shifted data signals each corresponding to one of a plurality of radio frequency bands different and independent from each other. The combiner circuit is configured to combine the frequency up-shifted data signals to generate a transmitting data signal to be transmitted to a target network node through a wired transmission media.

The present invention also discloses a high-speed home network receiving device serving as a receiver of a network node in a home network system that includes a plurality of band-pass filtering circuits, a plurality of mixer circuits, a plurality of receiving circuits and a traffic aggregating circuit. The plurality of band-pass filtering circuits are configured to receive a transmitting data signal from a source network node through a wired transmission media to separate the transmitting data signal into a plurality of band-pass data signals each corresponding to one of a plurality of separated frequency bands. The plurality of mixer circuits are configured to correspondingly perform frequency down-shifting on the plurality of band-pass data signals to generate a plurality of down-shifted data signals. The plurality of receiving circuits are configured to correspondingly process the plurality of down-shifted data signals to generate a plurality of processed data signals. The traffic aggregating circuit is configured to receive and perform reconstruction on the plurality of processed data signals to generate a data signal of a data stream.

The present invention further discloses a home network system that includes a wired transmission media, a first network node and a second network node. The first network node includes a high-speed home network transmitting device, the high-speed home network transmitting device including a traffic splitting circuit, a plurality of transmitting circuits, a plurality of mixer circuits and a combiner circuit. The traffic splitting circuit is configured to split a data signal of a data stream into a plurality of split data signals. The plurality of transmitting circuits are configured to correspondingly process the plurality of split data signals to generate a plurality of first processed data signals. The plurality of mixer circuits are configured to correspondingly perform frequency up-shifting on the plurality of first processed data signals to generate a plurality of up-shifted data signals each corresponding to one of a plurality of radio frequency bands different and independent from each other. The combiner circuit is configured to combine the frequency up-shifted data signals to generate a transmitting data signal to be transmitted through a wired transmission media. The second network node includes a high-speed home network receiving device, the high-speed home network receiving device including a plurality of band-pass filtering circuits, a plurality of mixer circuits, a plurality of receiving circuits and a traffic aggregating circuit. The plurality of band-pass filtering circuits are configured to receive the transmitting data signal through the wired transmission media to separate the transmitting data signal into a plurality of band-pass data signals each corresponding to one of a plurality of separated frequency bands. The plurality of mixer circuits are configured to correspondingly perform frequency down-shifting on the plurality of band-pass data signals to generate a plurality of down-shifted data signals. The plurality of receiving circuits are configured to correspondingly process the plurality of down-shifted data signals to generate a plurality of second processed data signals. The traffic aggregating circuit is configured to receive and perform reconstruction on the plurality of second processed data signals to generate the data signal of the data stream.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates a block diagram of a home network system according to an embodiment of the present invention.

FIG. 2 illustrates a block diagram of a first network node, a second network node and the wired transmission media therebetween according to an embodiment of the present invention.

FIG. 3 illustrates a block diagram of the high-speed home network transmission device according to an embodiment of the present invention.

FIG. 4 illustrates a diagram of the plurality of radio frequency bands according to an embodiment of the present invention.

FIG. 5 illustrates a block diagram of the high-speed home network receiving device according to an embodiment of the present invention.

### DETAILED DESCRIPTION OF THE PREFERRED EMBODIMENTS

An aspect of the present invention is to provide a home network system and a high-speed home network transmission device and a high-speed home network receiving device thereof to integrate the high-speed home network transmission device and the high-speed home network receiving device to network nodes in the home network system to perform transmission of the data signal by using a plurality of frequency bands through the wired transmission media to perform signal transmission with high data rates across multiple frequency bands simultaneously.

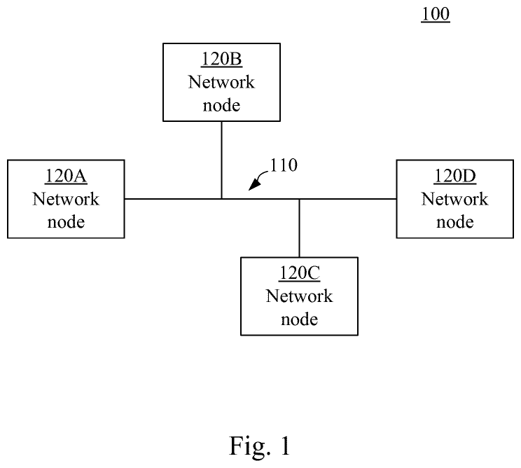

Reference is now made to FIG. 1. FIG. 1 illustrates a block diagram of a home network system 100 according to an embodiment of the present invention. The home network system 100 includes a wired transmission media 110 and a plurality of network nodes 120A˜120D.

The wired transmission media 110 is a coaxial cable or an optical fiber cable that is capable of performing signal transmission with a wider bandwidth. In a numerical example, the coaxial cable is capable of performing signal transmission with a bandwidth ranging from 1 GHz to 3 GHz, and the optical fiber cable is capable of performing signal transmission with a bandwidth of a range up to hundreds of GHz. However, the present invention is not limited thereto.

The network nodes 120A˜120D are configured to perform communication with each other through the wired transmission media 110. Each of the network nodes 120A˜120D can be a home gateway device, a switch device or a Wi-Fi communication device. For example, the network node 120A can be a home gateway device, the network node 120B can be a switch device, and each of the network node 120C and the network node 120D can be a Wi-Fi communication device. However, the present invention is not limited thereto.

It is appreciated that in different embodiments, the number of the network nodes in the home network system 100 can be different and is not limited to the number illustrated in FIG. 1.

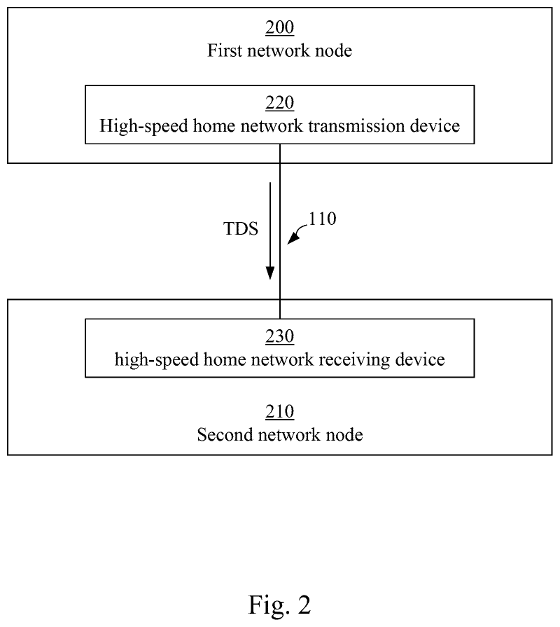

Reference is now made to FIG. 2. FIG. 2 illustrates a block diagram of a first network node 200, a second network node 210 and the wired transmission media 110 therebetween according to an embodiment of the present invention. The first network node 200 includes a high-speed home network transmission device 220. The second network node 210 includes a high-speed home network receiving device 230.

Each two of the network nodes 120A˜120D in FIG. 1 may serve as the first network node 200 and the second network node 210, in which the high-speed home network transmission device 220 serves as a transmitter of the first network node 200 to transmits a transmitting data signal TDS through the wired transmission media 110, and the high-speed home network receiving device 230 serves as a receiver of the second network node 210 to receive the transmitting data signal TDS through the wired transmission media 110.

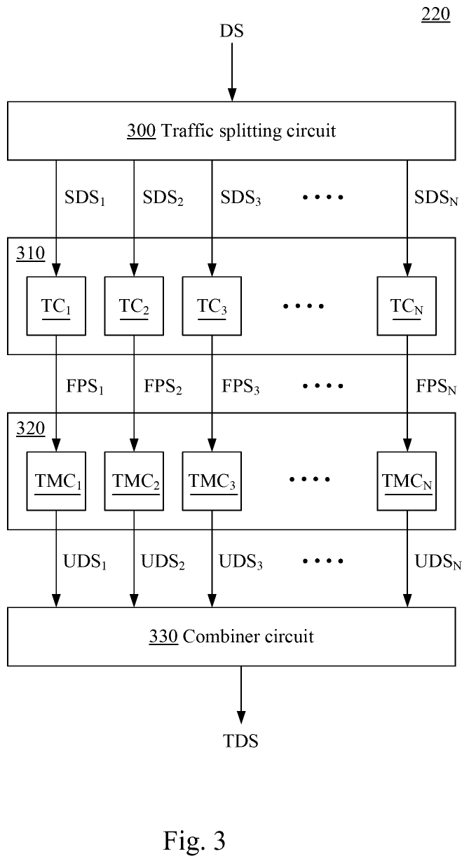

Reference is now made to FIG. 3. FIG. 3 illustrates a block diagram of the high-speed home network transmission device 220 according to an embodiment of the present invention. The high-speed home network transmission device 220 includes a traffic splitting circuit 300, a plurality of transmitting circuits 310, a plurality of mixer circuits 320 and a combiner circuit 330.

The traffic splitting circuit 300 is configured to split a data signal DS of a data stream into a plurality of split data signals SDS₁˜SDS_{N}. Each of the split data signals SDS₁˜SDS_{N} is portion of the data signal DS. In an embodiment, the data stream can be generated by a processing circuit (not illustrated) of the first network node 200.

The plurality of transmitting circuits 310 include the transmitting circuits TC₁˜TC_{N} labeled in FIG. 3, and are configured to correspondingly process the plurality of split data signals SDS₁˜SDS_{N} to generate a plurality of first processed data signals FPS₁˜FPS_{N}, in which N is an integer larger than 1. In an embodiment, the plurality of transmitting circuits 310 are configured to process the plurality of split data signals SDS₁˜SDS_{N} by performing signal modulation, analog-to-digital conversion, amplification or a combination thereof to generate the plurality of first processed data signals FPS₁˜FPS_{N}.

The plurality of mixer circuits 320 include the mixer circuits TMC₁˜TMC_{N} labeled in FIG. 3, and are configured to correspondingly perform frequency up-shifting on the plurality of first processed data signals FPS₁˜FPS_{N} to generate a plurality of up-shifted data signals UDS₁˜UDS_{N} each corresponding to one of a plurality of radio frequency bands different and independent from each other.

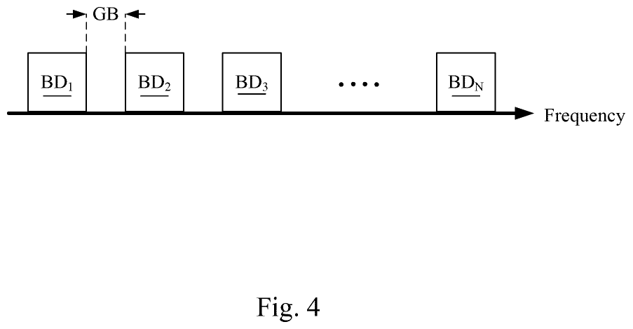

Reference is now made to FIG. 4 illustrates a diagram of the plurality of radio frequency bands BD₁˜BD_{N} according to an embodiment of the present invention. In FIG. 4, the X-axis stands for the frequency.

In an embodiment, each neighboring two of the radio frequency bands BD₁˜BD_{N} include a guard band therebetween such that the neighboring two of the radio frequency bands BD₁˜BD_{N} do not overlap. For example, the radio frequency bands BD₁ and BD₂ include a guard band GB therebetween in FIG. 4 such that the radio frequency bands BD₁ and BD₂ do not overlap.

As a result, the guard band acts as a buffer to prevent the interference between the neighboring two of the radio frequency bands BD₁˜BD_{N}. The integrity of the transmissions of the up-shifted data signals UDS₁˜UDS_{N} within each of the radio frequency bands BD₁˜BD_{N} can be maintained.

It is appreciated that the radio frequency bands BD₁˜BD_{N} in FIG. 4 are illustrated to have the same size. However, in practical implementation, the size of each of the radio frequency bands BD₁˜BD_{N} can be different from each other or partially the same with each other, such that the plurality of transmitting circuits 310 may perform different processing on the split data signals SDS₁˜SDS_{N} to generate the first processed data signals FPS₁˜FPS_{N} having different characteristics suitable to the range of the radio frequency bands BD₁˜BD_{N} for the plurality of mixer circuits 320 to perform frequency up-conversion.

The combiner circuit 330 is configured to combine the frequency up-shifted data signals UDS₁˜UDS_{N} to generate the transmitting data signal TDS to be transmitted to a target network node, which is the second network node 210 in FIG. 2, through the wired transmission media 110.

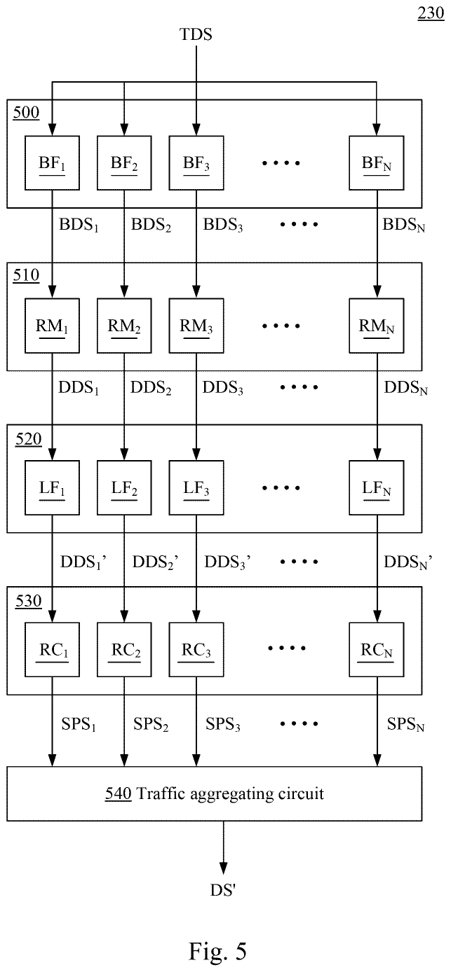

Reference is now made to FIG. 5. FIG. 5 illustrates a block diagram of the high-speed home network receiving device 230 according to an embodiment of the present invention. The high-speed home network receiving device 230 includes a plurality of band-pass filtering circuits 500, a plurality of mixer circuits 510, a plurality of low-pass filtering circuits 520, a plurality of receiving circuits 530 and a traffic aggregating circuit 540.

The plurality of band-pass filtering circuits 500 include the band-pass filtering circuits BF₁˜BF_{N} labeled in FIG. 5, and are configured to receive a transmitting data signal TDS from a source network node, which is the first network node 200 in FIG. 2, through the wired transmission media 110 to separate the transmitting data signal TDS into a plurality of band-pass data signals BDS₁˜BDS_{N} each corresponding to one of a plurality of separated frequency bands.

It is appreciated that the number of the band-pass data signals BDS₁˜BDS_{N} illustrated in FIG. 5 is N, which is the same as the number of radio frequency bands BD₁˜BD_{N}. However, in practical implementation, the number and the range of the separated frequency bands are not necessarily equal to those of the radio frequency bands BD₁˜BD_{N}. Further, the size of each of the separated frequency bands can also be either exactly the same, different from each other or partially the same with each other.

The plurality of mixer circuits 510 include the mixer circuits RM₁˜RM_{N} labeled in FIG. 5, and are configured to correspondingly perform frequency down-shifting on the plurality of band-pass data signals BDS₁˜BDS_{N} to generate a plurality of down-shifted data signals DDS₁˜DDS_{N}.

The plurality of low-pass filtering circuits 520 include the low-pass filtering circuits LF₁˜LF_{N} labeled in FIG. 5, and are configured to perform low-pass filtering on the plurality of down-shifted data signals DDS₁′˜DDS_{N}′ so as to be further processed by the plurality of receiving circuits 530. More specifically, the low-pass filtering circuits 520 can be selectively disposed in the high-speed home network receiving device 230 to remove the high-frequency components in the down-shifted data signals DDS₁˜DDS_{N}.

The plurality of receiving circuits 530 include the receiving circuits RC₁˜RC_{N} labeled in FIG. 5, and are configured to correspondingly process the plurality of down-shifted data signals DDS₁′˜DDS_{N}′ to generate a plurality of second processed data signals SPS₁˜SPS_{N}. In an embodiment, the plurality of receiving circuits RC₁˜RC_{N} are configured to process the plurality of down-shifted data signals DDS₁′˜DDS_{N}′ by performing signal modulation, digital-to-analog conversion, amplification or a combination thereof to generate the plurality of second processed data signals SPS₁˜SPS_{N}.

The traffic aggregating circuit 540 is configured to receive and perform reconstruction on the plurality of second processed data signals SPS₁˜SPS_{N} to generate the data signal DS′ of the data stream. In an embodiment, the data stream can be further sent to a processing circuit (not illustrated) of the second network node 210.

In the high-speed home network transmission device 220 and the high-speed home network receiving device 230 described above, the baseband modulation techniques such as Orthogonal Frequency-Division Multiplexing (OFDM), Quadrature Amplitude Modulation (QAM), Discrete Multitone Modulation (DMT) or other existing modulation techniques can be used to perform modulation and demodulation therein. The present invention is not limited thereto.

Further, though the condition that the first network node 200 includes the high-speed home network transmission device 220 and the second network node 210 includes the high-speed home network receiving device 230 is illustrated in FIG. 2, the first network node 200 may also include the high-speed home network receiving device 230 and the second network node 210 may also include the high-speed home network transmission device 220 such that the first network node 200 and the second network node 210 can perform bi-directional communication. The present invention is not limited thereto.

It is appreciated that the embodiments described above are merely an example. In other embodiments, it is appreciated that many modifications and changes may be made by those of ordinary skill in the art without departing, from the spirit of the invention.

In summary, the home network system and the high-speed home network transmission device and the high-speed home network receiving device thereof of the present invention integrate the high-speed home network transmission device and the high-speed home network receiving device to network nodes in the home network system to perform transmission of the data signal by using a plurality of frequency bands through the wired transmission media to efficiently perform signal transmission with high data rates across multiple frequency bands simultaneously.

The aforementioned descriptions represent merely the preferred embodiments of the present disclosure, without any intention to limit the scope of the present disclosure thereto. Various equivalent changes, alterations, or modifications based on the claims of present disclosure are all consequently viewed as being embraced by the scope of the present disclosure.

What is claimed is:

1. A high-speed home network transmission device serving as a transmitter of a network
node in a home network system, comprising:
a traffic splitting circuit configured to split a data signal of a data stream into a plurality of split data signals;
a plurality of transmitting circuits configured to correspondingly process the plurality of split data signals to generate a plurality of processed data signals;
a plurality of mixer circuits configured to correspondingly perform frequency up-shifting on the plurality of processed data signals to generate a plurality of up-shifted data signals each corresponding to one of a plurality of radio frequency bands different and independent from each other; and
a combiner circuit configured to combine the frequency up-shifted data signals to generate a transmitting data signal to be transmitted to a target network node through a wired transmission media.

2. The high-speed home network transmission device of claim 1, wherein each neighboring two of the radio frequency bands comprise a guard band such that the neighboring two of the radio frequency bands do not overlap.

3. The high-speed home network transmission device of claim 1, wherein the wired transmission media is a coaxial cable or an optical fiber cable.

4. The high-speed home network transmission device of claim 1, wherein the plurality of transmitting circuits are configured to process the plurality of split data signals by performing signal modulation, analog-to-digital conversion, amplification or a combination thereof to generate the plurality of processed data signals.

5. A high-speed home network receiving device serving as a receiver of a network node
in a home network system, comprising:
a plurality of band-pass filtering circuits configured to receive a transmitting data signal from a source network node through a wired transmission media to separate the transmitting data signal into a plurality of band-pass data signals each corresponding to one of a plurality of separated frequency bands;
a plurality of mixer circuits configured to correspondingly perform frequency down-shifting on the plurality of band-pass data signals to generate a plurality of down-shifted data signals;
a plurality of receiving circuits configured to correspondingly process the plurality of down-shifted data signals to generate a plurality of processed data signals; and
a traffic aggregating circuit configured to receive and perform reconstruction on the plurality of processed data signals to generate a data signal of a data stream.

6. The high-speed home network receiving device of claim 5, further comprising:
a plurality of low-pass filtering circuits configured to perform low-pass filtering on the plurality of down-shifted data signals so as to be further processed by the plurality of receiving circuits.

7. The high-speed home network receiving device of claim 5, wherein the wired transmission media is a coaxial cable or an optical fiber cable.

8. The high-speed home network receiving device of claim 5, wherein the plurality of receiving circuits are configured to process the plurality of down-shifted data signals by performing signal modulation, digital-to-analog conversion, amplification or a combination thereof to generate the plurality of processed data signals.

9. A home network system, comprising:
a wired transmission media;
a first network node comprising a high-speed home network transmitting device, the high-speed home network transmitting device comprising:
a traffic splitting circuit configured to split a data signal of a data stream into a plurality of split data signals;
a plurality of transmitting circuits configured to correspondingly process the plurality of split data signals to generate a plurality of first processed data signals;
a plurality of mixer circuits configured to correspondingly perform frequency up-shifting on the plurality of first processed data signals to generate a plurality of up-shifted data signals each corresponding to one of a plurality of radio frequency bands different and independent from each other; and
a combiner circuit configured to combine the frequency up-shifted data signals to generate a transmitting data signal to be transmitted through a wired transmission media; and
a second network node comprising a high-speed home network receiving device, the high-speed home network receiving device comprising:
a plurality of band-pass filtering circuits configured to receive the transmitting data signal through the wired transmission media to separate the transmitting data signal into a plurality of band-pass data signals each corresponding to one of a plurality of separated frequency bands;
a plurality of mixer circuits configured to correspondingly perform frequency down-shifting on the plurality of band-pass data signals to generate a plurality of down-shifted data signals;
a plurality of receiving circuits configured to correspondingly process the plurality of down-shifted data signals to generate a plurality of second processed data signals; and
a traffic aggregating circuit configured to receive and perform reconstruction on the plurality of second processed data signals to generate the data signal of the data stream.

10. The home network system of claim 9, wherein each neighboring two of the radio frequency bands comprise a guard band such that the neighboring two of the radio frequency bands do not overlap.

11. The home network system of claim 9, wherein the wired transmission media is a coaxial cable or an optical fiber cable.

12. The home network system of claim 9, wherein the plurality of transmitting circuits
are configured to process the plurality of split data signals by performing signal modulation, analog-to-digital conversion, amplification or a combination thereof to generate the plurality of first processed data signals; and
the plurality of receiving circuits are configured to process the plurality of down-shifted data signals by performing signal modulation, digital-to-analog conversion, amplification or a combination thereof to generate the plurality of second processed data signals.

13. The home network system of claim 9, wherein the high-speed home network
receiving device further comprises:
a plurality of low-pass filtering circuits configured to perform low-pass filtering on the plurality of down-shifted data signals so as to be further processed by the plurality of receiving circuits.

14. The home network system of claim 9, wherein each of the first network node and the second network node is a home gateway device, a switch device or a Wi-Fi communication device.
